(19) United States
(12) Patent Application Publication
(10) Pub. No.: US 2023/0332457 A1
(43) Pub. Date: Oct. 19, 2023

(54) METHOD FOR CONTROLLING A DOOR SYSTEM

(71) Applicant: dormakaba Deutschland GmbH, Ennepetal (DE)

(72) Inventors: Dennis MEIERING, Ennepetal (DE); Sven BUSCH, Ennepetal (DE); Patrick WINKELMANN, Ennepetal (DE); Boon Ping OOI, Ennepetal (DE)

(21) Appl. No.: 18/300,058

(22) Filed: Apr. 13, 2023

(30) Foreign Application Priority Data
Apr. 18, 2022 (EP) 22168693.4

(51) Int. Cl. E05F 15/76; G07C 9/29; G06N 20/00

(52) U.S. Cl. CPC E05F 15/76; G07C 9/29; G06N 20/00; E05F 2015/767

(57) ABSTRACT

A method for controlling at least one door system for separating an entrance side in front of the door system from an exit side behind the door system, with the door system (100) being configured with a sensor unit for detecting at least one person within a sensor detection region, and furthermore an authentication device for authenticating people is provided at least on the entrance side in front of the door system. The method includes the following steps: granting an access authorization to the person by the authentication device, detecting the position of the authenticated person by the sensor unit in the sensor detection region, continuously tracking the person in the sensor detection region by the sensor unit and activating an opening of the leaf element of the door system by the door drive when the authenticated person approaches the at least one leaf element.

### CROSS-REFERENCE TO RELATED APPLICATIONS

This application claims the benefit of European patent application 22168693.4, filed on 18 Apr. 2022, the disclosure of which is incorporated herein by reference in its entirety.

### TECHNICAL FIELD

The present disclosure relates to a method for controlling at least one door system for separating an entrance side in front of the door system from an exit side behind the door system, with the door system having at least one door drive for moving at least one leaf element between an open position and a closed position, and with the door system being configured with a sensor unit for detecting at least one person within a sensor detection region, and furthermore an authentication device for authenticating people is provided on the entrance side in front of the door system. The disclosure also relates to a door system with a regulating unit for carrying out the method.

### BACKGROUND

Door drives are known, which are connected to sensor units designed to detect people, for controlling automatic door systems, in particular sliding door systems. Such door systems are controlled by control units that record the sensor data of the sensor units and output corresponding control pulses to the door drive.

Thus, for example DE 203 20 497 U1 shows a door system having a door drive and having a sensor unit, with the sensor unit serving as a presence sensor and with which the presence of people can be detected in a detection area. When the person is detected, the opening of the door leaf of the door system is triggered via the door drive. In this case, it is indicated that radar sensors can also be used as the sensor unit. Disadvantageously, however, only a simple opening pulse is usually generated by the control unit as soon as the sensor unit detects the presence of a person and transmits the detection to the control unit as corresponding sensor data. A leaf movement can be triggered, but this often starts too early or too late or is unsuitable in some other way, for example if the opening movement of the door leaf is too slow or the opening hold duration is too short or too long.

An optimum for the control of door systems is, in particular, making it possible for people to pass through the door system in such a way that the movement of the at least one leaf element does not affect the walking movement of the person. On the other hand, however, the opening duration of the door leaf should not last too long, for example in order to minimize heat loss indoors when outside temperatures are low. In this respect, the leaf element should not be out of the closed position longer than necessary in order to avoid energy losses.

Modern door systems can also have access control systems that only allow authenticated people through the door. Disadvantageously, the not always reliable functioning of sensors in the sensor units leads to malfunctions or a first person authenticates themselves, whereupon a second person can pass through the door system unnoticed, which is to be avoided.

For example, EP 3 188 134 B1 discloses a method for checking access authorizations using an access control system, for example on a ski lift or in sensitive areas of a company, with access authorizations stored on data carriers or mobile electronic devices such as mobile phones being detected and read contactlessly, with a plurality of reading devices being provided on the entrance side of the access control system, which cover the entire entrance region, with a plurality of cameras connected to the server being provided on the entrance side of the access control system, which cover the entire entrance region, and, within the scope of the method by means of detecting the data carriers or the mobile electronic devices, on which a valid access authorization is stored, the current position of the mobile electronic device is determined by at least three reading devices by trilateration or multilateration, and with the current position of all people present in the entrance region of the access control system being detected by means of the cameras using a second imaging method, which is carried out parallel to the first method. In this context, the camera can generally be viewed as a sensor unit, with which people are detected and tracked in a sensor detection region.

### SUMMARY

The disclosure further improves a method for operating a door system, with which a wide range of options for authenticating people can also be provided for door systems. In addition, the door system should be able to offer a high level of convenience for authenticated people, although the leaf elements of the door system should not remain in the open position longer than necessary. Furthermore, the door system should also be able to be operated fully with the possibilities of person authentication with only the minimum possible number of sensor units.

This advantage is achieved proceeding from a method according to the preamble of the claim 1 and according to a door system according to claim 12 each with the characterizing features. Advantageous further developments of the disclosure are each indicated in the dependent claims.

The method according to the disclosure for controlling a door system provides at least the following steps: Granting an access authorization to the person by means of the authentication device, detecting the position of the authenticated person by means of the sensor unit in the sensor detection region, continuously tracking the person in the sensor detection region by means of the sensor unit and activating an opening of the leaf element of the door system by means of the door drive when the authenticated person approaches the at least one leaf element.

The term authenticated is used below synonymously with the term authorized to enter.

The core idea of the disclosure is the use of sensor units of a door system, which span a sensor detection region both on the entrance side and on the exit side of the door system, and people who enter the sensor detection region are detected by the sensor unit and the leaf elements can be moved in the usual way from a closed position into an open position. According to the disclosure, these sensor units, which are known per se, should also be used to monitor one or a plurality of people in the sensor detection region in their continuous movement, for example if they are still in the sensor detection region on the entrance side of the door system for a while after authentication by the authentication device, and the tracking of the person can also take place before the authentication by means of the authentication device. The sensor units can thereby be designed such that a person can actually be tracked within the sensor detection region, even in the presence of other, in particular unauthenticated, people. This creates the possibility that a time can also lapse between the moment the person is authenticated at the authentication device and the actual entry into the door system, for example when the person approaches the leaf elements directly and the desire to enter is recognized by the same sensor unit.

Although the method is aimed at the access authorization of people, they are also representative of objects, for example moving objects, robots and the like. Of course, unauthenticated people can also be tracked by means of the sensor unit, which is advantageous in particular at a shorter distance from the authenticated person, such that the door system does not open when the unauthenticated person is within a range of up to 3 m or 2 m or 1 m or 50 cm from the authenticated person. In this respect, a plurality of or preferably all people who are in the detection region can be tracked electronically by means of the sensor unit.

In the present case, for better understanding and for easier description, the method is presented in connection with people, and instead of the person or people in general, an object or objects can also pass through the door system or can be detected by the sensor units. In particular, these objects can be general objects carried by people or, for example, self-propelled transport systems or robots.

In particular, the method according to the disclosure for controlling the door system is made possible with a regulating unit that is configured as part of the door system and that continuously and dynamically on an ongoing basis regulates the position of the leaf element based on the sensor data of the sensor unit as a function of the movement and/or the contour of the person. The regulating unit enables both the tracking of the authenticated person within the sensor detection region and the immediate triggering of a response of the at least one leaf element when the person approaches. The position of the at least one leaf element is regulated by means of the regulating unit, preferably indirectly via at least one door drive.

The regulating unit enables the creation of a closed control loop made up of the regulating unit, the sensor unit for detecting the person and the door drive for driving the leaf element. This closed control loop enables the leaf element to follow the movement and contour of the person directly, and if the person approaches the door system, for example, and the leaf element is moved into the open movement by the authentication of the person, then if the movement of the person is interrupted or if the distance between the person and the door system changes and increases, the leaf element can also immediately execute a closing movement again.

The movement of the leaf element can be controlled directly thereafter as a function of the movement of the person in this respect. The contour of the person describes, for example, the movement of the person, such as when the person stretches out an arm or a leg, such that the leaf element can also react by detecting the change in the contour of the person by way of the sensor unit. Only with such a regulating unit is it possible not only to trigger a simple opening impulse to open a leaf element when an authenticated person approaches the door system, for example, and when the desire to enter is recognized, but the leaf element also closes again immediately when the person, for example, does not enter the door system and moves away again. This effectively prevents, for example, an unauthenticated person from being able to pass through the door system.

In a preferred embodiment, access to an otherwise blocked-off area, in particular a room or a region of the airport, can be made possible by the door system. Furthermore, the door system or another door system can be used to selectively enable the exit from this blocked-off area. In particular, a step can be taken that includes granting an exit authorization to the person by means of the detection device or another detection device. The person is preferably continuously tracked in the blocked-off area by means of the sensor unit or another sensor unit. In particular, the exit authorization can depend on whether the person being tracked has entered into a specific zone of the blocked-off area, in particular alone. Alternatively or cumulatively, the exit authorization can depend on whether another successful authentication has taken place, in particular by means of another authentication device.

It is conceivable that at least the one door system is designed as a pivotable and/or rotatable or sliding door device, in particular as:
a hinged door,
a revolving door,
a security revolving door,
a sliding door,
a bifold door,
tripod turnstile,
a turnstile,
a pivot door.

It is preferably conceivable that the person authorized to exit is differentiated from a person not authorized to exit by means of the regulating unit or another regulating unit by providing the person authorized to exit with an additional electronic tag after the authorization to exit has been granted, which is electronically attached to the person. The people can be differentiated since the person is continuously tracked in the sensor detection region by means of the sensor unit. So this tag can be tracked along with the person.

Due to the continuous tracking of the person by means of the sensor unit and/or another sensor unit, an opening of the door system or the other door system can be activated in particular by means of the regulating unit or another regulating unit when the person authorized to exit approaches the door system and/or the other door system. In this way, the person authorized to enter a blocked-off region can first safely enter the blocked-off region. Furthermore, precisely this person can be checked in the blocked-off region, in particular for specific actions, such that this person can be granted an exit authorization. If this person is authorized to exit, this person can be allowed to exit the blocked-off region. This process is made possible in particular due to the continuous tracking of the person by means of the sensor unit and/or another sensor unit. In particular, this process can take place without security personnel. A signal can be issued if the authorizations are violated. In this way, the security personnel can be informed.

In particular, the authenticated person is differentiated from the unauthenticated person with the regulating unit by the authenticated person being provided with an electronic tag after authentication, which is actually attached to the person electronically in the regulating unit. At least one image evaluation unit is preferably configured in connection with the at least one sensor unit, with the continuous tracking of the movement of the person over their entire detection duration and/or the entire detection region being carried out at least in a supporting manner by means of the image evaluation unit and made available to the regulating unit.

As described below in the exemplary embodiments, the electronic tag can be a type of electronic tag. The tag can thus be visual or virtual, with it being suitable for distinguishing the authenticated person from an unauthenticated person by means of the sensor unit and/or the image evaluation unit and/or the regulating unit. The tag is electronic insofar as it is generated on an electronic device, in particular the sensor unit and/or the image evaluation unit and/or the regulating unit.

Corresponding attributes of the person can be recognized by means of the image evaluation unit, with the authenticated person being recognized, for example, by the fact that, at the time of authentication, the person in question was standing in the immediate vicinity, for example directly in front of the authentication device, and can be provided with the electronic tag accordingly. If the authenticated person moves away from the authentication device within the sensor detection region, the electronic tag of the person may remain attached, thereby retaining the authentication. In this way, the person can actually pass through the door system at a later point in time, and the regulating unit triggers the opening of the leaf elements.

In this case, the image evaluation unit can also recognize specific attributes of the person, for example the size or other contour. If the image evaluation unit can distinguish the person from other people, for example based on the size, the color, the colors or the contour, in addition to the continuous tracking of the movement of the person, this person can also be identified by other features, whereby reliability is increased such that the door system actually only allows authenticated persons to pass through. In particular, contour recognition can be carried out by means of artificial intelligence. Such contour recognition by means of artificial intelligence can be used for re-authentication and/or for continuous tracking of the movement of the person.

As described below, facial recognition, in particular anonymized facial recognition, and/or pattern recognition, in particular by means of artificial intelligence, can be used for this purpose as an alternative or in addition.

As previously described, specific attributes of the person, for example size or other contour, can be recognized for re-authentication and/or for continuous tracking of the movement of the person, in particular by means of artificial intelligence. If the person can be distinguished from other people, for example based on the size, the colors or the contour, in addition to the continuous tracking of the movement of the person and/or for the continuous tracking of the movement of the person, the person can also be identified on the basis of other features, in particular by means of the image evaluation unit, in particular,
whether certain body parts of a person are recognized and/or
whether certain items of clothing are recognized and/or
whether a certain form of movement is recognized.

This can also be done by means of artificial intelligence. As described below, this can be done by means of an artificial intelligence system, preferably as part of the regulating unit. It is conceivable that the artificial intelligence system has and/or implements a machine learning system, a deep learning system, a neural network, contour recognition and/or pattern recognition. A maximum amount of information about the detection region can thus be supplied with a simple and inexpensive sensor unit. The attributes and/or features described above can be understood as part of pattern recognition.

To re-authenticate the person if the person leaves the detection region before the door system has been passed, and/or if the person enters another door system downstream of the door system or another door system that is configured to be accessible in parallel, the described attributes and/or features are stored in the regulating unit, in particular for a predetermined period of time. The stored attributes and/or features can then be used as a new authentication criterion by means of the regulating unit and/or by means of a common regulating unit and/or by means of a central regulating unit and/or by means of another regulating unit of another door system. As a result, the original authentication, which in most cases involves more effort, can be replaced by the new authentication criterion.

The attributes and/or features described can also be used to continuously track the movement of the person if a common detection region is spanned by means of a plurality of sensor units. The attributes and/or features described can then be used to transfer the person from the region of one sensor unit to the region of another sensor unit such that the person can be tracked continuously and thus without interruption.

As an alternative or in addition to an authentication device in the form of a so-called access point, the person can carry an electronic communication means with them, and the door system and/or the sensor unit can have a detection device as the authentication device. Then, when the person enters the sensor detection region, the electronic communication means can be detected by the detection device in spatial connection with the person carrying it, and then the electronic tag can be attached to the person carrying it. The prerequisite for this is that the electronic communication means, for example a mobile phone, remains in the possession of the person.

A further increase in security against unauthorized entry into a room is achieved, for example, in that when the authenticated person approaches the at least one leaf element, the regulating unit only opens the at least one leaf element so far and/or for so long that only the authenticated person can pass through the door system.

Further advantageously, the method provides that a sensor unit is configured on the entrance side and on the exit side of the door system in each case and/or with the sensor detection regions of both sensor units overlapping, adjoining one another or at least having a distance from one another that is smaller than the dimension of an in particular small person, such that the at least one object is detected passing from a first sensor detection region to the one second sensor detection region and in particular without interruption.

The door system preferably has two leaf elements, with the movements of the leaf elements being regulated continuously and dynamically on an ongoing basis independently of one another by means of the regulating unit, at least indirectly via the door drives.

In particular, the door system is designed as a sliding door system and has two leaf elements guided in a common plane of movement, with the movements of the leaf elements being regulated continuously and dynamically on an ongoing basis independently of one another by means of the regulating unit. The regulation takes place in such a way that the movement of the leaf elements represents a direct response to the movement or a change in the contour of a person who indicates a desire to enter. For example, if the person approaches the leaf elements of the door system, they open in particular at the position where the person is, such that an entry path is created for the person through the door system. If the person moves to the side, for example, one leaf element moves further into the open position, while the other leaf element moves further into the closed position, for example. Consequently, the leaf elements can be adapted to the position and the movement as well as the contour of the person such that the response in the movement of the leaf elements responds to the position, the movement direction and the movement speed of the person as well as the contour of the person. Only with this regulating technology and with the design of an active control loop can the present principle of authentication and continued tracking of the authenticated person take place, while the authenticated person can be distinguished from people who do not have any authentication.

The method preferably also makes it possible to provide protection of the closing edges of the at least one leaf element of the door system with the at least one sensor unit and with the associated sensor detection region. The protection of the closing edges is based on the evaluation of sensor data from the sensor unit, in particular via the regulating unit. There is no need for additional sensors to protect the closing edges.

In the present sense and/or abstractly, the regulating unit also designates a more simply designed control unit that can be programmed, for example, such that the at least one leaf element interrupts a movement, in particular into the closed position, as soon as there is a collision with a person or an object. If there is a sensor unit on the entrance side and on the exit side of the door system in each case, the sensor detection regions of both sensor units can overlap such that seamless monitoring of the closing edges of the leaf elements is possible. If the sensor detection regions of both sensor units overlap, redundant protection of the closing edges can even be implemented.

The sensor detection regions do not necessarily have to overlap and they do not have to be approximately adjacent to one another, since a person generally has a spatial expansion. The distance between the sensor detection regions of both sensor units on the opposing door sides should be at least small enough to prevent a small person, such as a child, from remaining undetected between the sensor detection regions. If there is a gap in detection between the sensor detection regions on the opposing door sides, this can be filled by interpolation such that there is practically no need to interrupt the regulation.

According to a further advantageous configuration, the door system and/or at least the sensor unit can have at least one imaging camera with which the face of the person can be recognized, in particular in operative connection with the regulating unit. The method can thus be developed such that the recognition and identification of the person is also taken into account for determining an authentication or access authorization for the door system.

For example, an access authorization with the face of the authorized person can be stored in a data memory that can be kept locally or in the cloud. If the desire to enter of the authenticated person is recognized via the authentication device either in the form of an access point or via the detection of the electronic communication means via the detection device, the person can also be recognized with the imaging camera by the fact that the face is also checked when entering the door system. The door system only opens if the face of the person entering the door system and currently being recorded, matches the face that is stored for the authorization of the person concerned. If the face recorded via the imaging camera does not match the person stored with the authentication, the door system will not open. As an alternative to the face, other attributes and/or features of the person can also be recognized, for example size, contour, form of movement and the like.

The method can also be used to control a plurality of door systems, with the plurality of door systems being arranged parallel to one another, for example, and having a common entrance side and a common exit side. The plurality of door systems can be controlled by means of a common regulating unit, or it is provided that the plurality of door systems have respective regulating units between which data is exchanged, and when a person is authenticated by means of the at least one authentication device and/or the at least one detection device at a first door system, the person can also pass through a second door system configured in parallel.

For example, at airports, door systems consisting of a plurality of individual door systems are known. If a person authenticates themselves, for example, at an access point or by means of an electronic communication means at a first door system, this person can also pass through another door system arranged in parallel. Systems of this type are advantageous when, for example, a plurality of people are in line at the door systems, for example when the door systems are used to separate people, as is known at airports. It thereby happens that people authenticate themselves at a first corresponding device, which is assigned to a first door system, but the person wants to pass through another door system arranged in parallel. Through a central regulating unit or through an electronic data connection between the respective regulating units of the door systems, a person who has been authenticated once can also pass through another door system at which the person has not authenticated themselves.

Alternatively, however, it can be provided that the authenticated person may only pass through the door system whose authentication device has been used. In this case in particular, the central regulating unit can activate a signal which requests entry into the correct activated door system.

This is made possible in particular by the continuous tracking of the person by means of the sensor unit as long as the person is within the sensor detection region. The sensor detection regions of the sensor units of the individual door systems preferably overlap such that a person can also be tracked continuously from door system to door system. A person, who has an electronic tag that forms the authentication for passing through the door system, can retain this tag attached to them, even if the person moves in front of the plurality of door systems in such a way that the person leaves the individual sensor detection regions of the sensor units of the associated door systems and enters a next sensor region.

In a preferred embodiment, access to an otherwise blocked-off area, in particular a room or a region of the airport, can be made possible by the door system. Furthermore, the door system or another door system can be used to enable the exit from this blocked-off area. In particular, a step can be taken that includes:
granting an exit authorization to the person by means of the authentication device and/or detection device or another authentication device and/or another detection device.

The person is preferably continuously tracked in the blocked-off area by means of the sensor unit or another sensor unit. In particular, the exit authorization can depend on whether the person being tracked has entered a specific zone of the blocked-off area, in particular alone. Alternatively or cumulatively, the exit authorization can depend on whether another successful authentication has taken place, in particular by means of another authentication device. This can be done in such manner that the person authorized to exit is differentiated from a person not authorized to exit by means of the regulating unit or another regulating unit by providing the person authorized to exit with an additional electronic tag after the authorization to exit has been granted, which is electronically attached to the person. Due to the continuous tracking of the person by means of the sensor unit and/or another sensor unit, an opening of the door system or the other door system can be activated in particular by means of the regulating unit or the other regulating unit when the person authorized to exit approaches the door system and/or the other door system. In this way, the person authorized to enter a blocked-off region can first safely enter the blocked-off region. Furthermore, this person can be checked in the blocked-off region, in particular for specific actions, such that this person can be granted an exit authorization. If this person is authorized to exit, this person can be allowed to exit the blocked-off region. This process is made possible in particular due to the continuous tracking of the person by means of the sensor unit and/or another sensor unit. In particular, this process can take place without security personnel. A signal can be issued if the authorizations are violated. In this way, the security personnel can be informed.

The disclosure is also aimed at a door system with a regulating unit for carrying out the method described above. The regulating unit is preferably designed in connection with at least one sensor unit such that an authenticated person can be distinguished from an unauthenticated person by the regulating unit and/or the sensor unit tracking a person who has been authenticated once within the sensor detection region.

In particular, the door system and/or in particular the regulating unit has a sound, light and/or voice output means in order to give a signal or provide a voice message to the person. For example, the person can receive a corresponding signal in the event of a positive authentication. The regulating unit can then deliver, in particular a message, to a superordinate system.

The sensor unit preferably has at least one and preferably two cameras, and in particular the sensor unit has at least one light source with which a light grid can be projected into the sensor detection region. This enables image processing by means of an image evaluation unit, which can be part of the sensor unit or part of the regulating unit, or the image evaluation unit forms a separate structural unit.

In addition, the sensor unit can have an imaging camera for facial recognition of the person, in particular the facial recognition can be carried out in connection with the regulating unit and/or in connection with the image evaluation unit and/or artificial intelligence.

The sensor unit preferably has at least one, in particular a single, camera, preferably two cameras and/or the sensor unit has at least one light source with which a light grid can be projected into the sensor detection region and/or the sensor unit has a LiDAR sensor.

The sensor unit preferably has at least one and preferably two cameras and/or the sensor unit has at least one light source with which a light grid can be projected into the sensor detection region and/or the sensor unit has a LiDAR sensor.

In this respect, a plurality of image-processing or at least optically functioning sensor principles are conceivable within the scope of the disclosure, including stereo cameras, LiDAR sensors and/or the like. Thus, within the scope of the disclosure, distance measurement sensors are also conceivable that provide distances for a plurality of points in the detection region.

Preferably or exclusively, sensor units are used that are suitable for measuring distances between the sensor and surfaces, with the surfaces being formed by the objects to be detected and/or by objects in the environment such as floors, doors, frames and walls. Sensor units of this type determine the distance between the sensor and the surface either by the triangulation method and/or by measuring the travel time of radiation from a transmission source belonging to the sensor unit.

When using the triangulation method, the different directional angles become a defined surface point of at least two spaced reference points, which consist of two or more wave-sensitive sensors, e.g. line sensors or single-point sensors or cameras. Preferably, it is a stereo camera in this case. Alternatively, a wave-sensitive sensor, in particular a camera, and a punctiform reference light source, e.g. a point grid light source, are used in the triangulation method.

Preferred combinations in the triangulation method are:
1. The angle and/or distance is calculated by means of extraneous light, e.g. sun or room light and two or more wave-sensitive sensors
2. The angle and/or distance is calculated by means of the system's own light sources, preferably in a punctiform, e.g. point grid manner, and at least one wave-sensitive sensor
3. Combination of 1 and 2, which means that the sensor system is suitable for carrying out at least the distance calculation both in darkness and/or weak light and in very strong extraneous light.

When measuring the travel time of radiation, one or a plurality of transmission sources belonging to the sensor unit are used, which generate and emit the radiation in the form of electromagnetic waves, in particular light, radar, radio, X-rays, microwaves and/or sound waves, and project them onto the surfaces of the objects to be detected. A receiving system of the sensor unit, which is sensitive to the respective type of radiation, receives the rays reflected from the surfaces. Together with a calculation unit of the control unit or the sensor unit, the travel time required by the radiation from the time of emission to receipt in the receiving system is determined directly in the form of a time measurement and/or indirectly, in particular in the form of a measurement of interferences, phase shifts and/or frequency shifts, in particular in relation to the emitted radiation. The one or plurality of transmission source(s) can emit diffuse, i.e. scattered radiation, in particular in connection with a TOF camera, FMCW radar (FMCW=Frequency-Modulated Continuous Wave Radar Systems) and/or radiation focused on one or a plurality of points, in particular in connection with LiDAR (LiDAR stands for Light Detection and Ranging), laser array and/or laser scanner. Furthermore, the different regions of a sensor detection region can be illuminated with the radiation simultaneously and/or sequentially, i.e. in chronological succession, or combinations.

In particular, a method can be used which combines both the triangulation method and the measurement of the travel time of radiation from a transmission source belonging to the sensor unit.

As a result of the method, a distance image can be provided which includes the in particular complete sensor detection region from a plurality of individual distance measurement points.

A LiDAR sensor is particularly preferably used in connection with a method based on the distance measurement. This combination, in particular as well as the others mentioned, represents a particularly efficient option, in particular in terms of security and/or complexity.

Alternatively or cumulatively, the sensor unit can be designed as a wave-sensitive sensor, in particular any camera, whose data is analyzed by artificial intelligence, in particular an artificial intelligence system (AI system), preferably as part of the regulating unit. It is conceivable that the artificial intelligence system has and/or implements a machine learning system, a deep learning system, a neural network, contour recognition and/or pattern recognition. A maximum amount of information about the detection region can thus be supplied with a simple and inexpensive sensor unit.

In one embodiment, the AI-system comprises an underlying machine learning model. Suitable machine learning models are based on a convolutional neural network (CNN) or a recurrent neural network (RNN) or a combination thereof. CNNs and RNNs are both types of deep learning algorithms commonly used in machine learning applications. A CNN is a type of neural network that is particularly well-suited for image and video recognition tasks.

Generally speaking, a CNN uses convolutional layers to extract features from input data, followed by pooling layers to reduce the dimensionality of the feature maps. The output of the convolutional and pooling layers is then flattened and fed into one or more fully connected layers, which are responsible for making the final classification decision. The main advantage of CNNs is that they can automatically learn hierarchical representations of input data, which makes them very effective at recognizing complex patterns in images and videos.

An RNN, on the other hand, is a type of neural network that is particularly well-suited for sequence data, such as time series or natural language. An RNN uses recurrent connections to propagate information from one time step to the next. This enables the network to maintain an internal state or memory of previous inputs, which is useful for tasks such as speech recognition or language translation. The main advantage of RNNs is their ability to capture temporal dependencies in the input data, which makes them very effective at modeling sequential data.

One key difference between CNNs and RNNs is that CNNs are designed to operate on fixed-size input data (such as images of a fixed resolution), whereas RNNs can handle variable-length input data (such as sequences of different lengths). Another difference is that CNNs are better suited for tasks that involve spatial information (such as image classification), while RNNs are better suited for tasks that involve temporal information (such as speech recognition).

In an embodiment of the present disclosure, it may be provided to use a combination of both CNNs and RNNs since for video recognition tasks, both spatial and temporal information are important. A CNN can be used to extract spatial features from each frame of the video, which are then fed into an RNN to model the temporal dependencies between frames.

The machine learning model may be trained using a large dataset of labeled examples, where each example consists of a time series of data points and a corresponding label that indicates the type of attribute, feature, contour and/or pattern. The training data is used to adjust the weights and biases of the model so that it can accurately classify new, unseen examples. The training process typically involves an iterative approach, where the model is presented with a batch of training examples and the weights and biases are adjusted to minimize the difference between the predicted output and the actual label. This process is repeated for many epochs until the model has learned to accurately classify the attribute, feature, contour and/or pattern. in the training data.

The type of AI that may be used in this context is typically supervised learning, where the model is trained using a labeled dataset. However, unsupervised learning approaches such as clustering and anomaly detection can also be used in the context of the present disclosure, e.g., in order to fill in the database as mentioned above.

Certain embodiments of the disclosure may be based on using a machine-learning model or machine-learning algorithm. Machine learning may refer to algorithms and statistical models that computer systems may use to perform a specific task without using explicit instructions, instead relying on models and inference. For example, in machine-learning, instead of a rule-based transformation of data, a transformation of data may be used that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and/or training sequences (e.g. words or sentences) and associated training content information (e.g. labels or annotations), the machine-learning model “learns” to recognize the content of the images, so the content of images that are not included in the training data can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model. The provided data (e.g., sensor data, meta data and/or image data) may be preprocessed to obtain a feature vector, which is used as input to the machine-learning model.

Machine-learning models may be trained using training input data. The examples specified above use a training method called “supervised learning”. In supervised learning, the machine-learning model is trained using a plurality of training samples, wherein each sample may comprise a plurality of input data values, and a plurality of desired output values, i.e., each training sample is associated with a desired output value. By specifying both training samples and desired output values, the machine-learning model “learns” which output value to provide based on an input sample that is similar to the samples provided during the training. Apart from supervised learning, semi-supervised learning may be used. In semi-supervised learning, some of the training samples lack a corresponding desired output value. Supervised learning may be based on a supervised learning algorithm (e.g., a classification algorithm, a regression algorithm or a similarity learning algorithm). Classification algorithms may be used when the outputs are restricted to a limited set of values (categorical variables), i.e., the input is classified to one of the limited set of values. Regression algorithms may be used when the outputs may have any numerical value (within a range). Similarity learning algorithms may be similar to both classification and regression algorithms but are based on learning from examples using a similarity function that measures how similar or related two objects are. Apart from supervised or semi-supervised learning, unsupervised learning may be used to train the machine-learning model. In unsupervised learning, (only) input data might be supplied and an unsupervised learning algorithm may be used to find structure in the input data (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters. Reinforcement learning is a third group of machine-learning algorithms that may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Furthermore, some techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

### BRIEF DESCRIPTION OF THE DRAWINGS

Further measures that improve the disclosure will be outlined in greater detail below together with the description of a preferred exemplary embodiment of the disclosure on the basis of the figures, in which is shown:

FIG. 1 a schematic view of a door system for carrying out the method according to the disclosure,

FIG. 2a-2c the door system according to FIG. 1 with a plurality of people, with the people differing from one another in their authentication, and with the authentication taking place by means of an access point,

FIG. 3a-3c a further exemplary embodiment according to FIG. 2c, but with the authentication taking place via a detection device in connection with an electronic communication means and

FIG. 4a, 4b a door system with a plurality of individual door systems which are configured to be parallel to one another and which can be entered by a plurality of people.

### DETAILED DESCRIPTION OF THE DRAWINGS

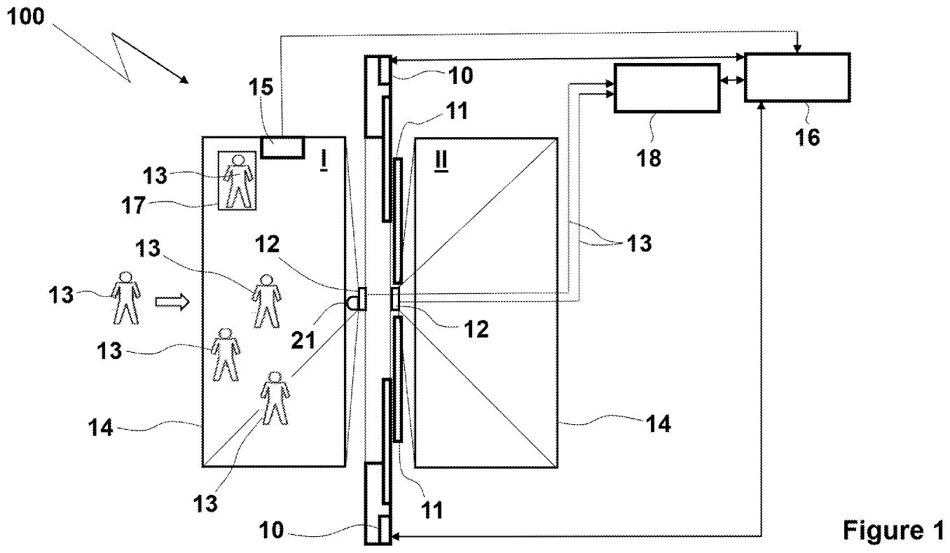

FIG. 1 shows a door system 100 in a schematic plan view, with the door system 100 being entered by a plurality of people 13 as an example. The door system 100 separates an entrance side I from an exit side II, with the illustrated people 13 being on the entrance side I of the door system 100.

The door system 100 has a first sensor unit 12 on the entrance side I, and another sensor unit 12 is provided on the exit side II. On the respective sides I and II, the sensor units 12 span sensor detection regions 14, within which the people 13 can be detected with the sensor units 12.

The door system 100 is designed, for example, as a sliding door system 100 and has two leaf elements 11 that can move in a common plane of movement between a closed position and an open position. To drive the leaf elements 11, respective door drives 10 are provided, which are each actuated by a regulating unit 16. The regulating unit 16 is connected to the sensor units 12 via an image evaluation unit 18.

The person 13 at the top has authenticated themselves at the authentication device 15 on the entrance side I, for example, and thus receives a type of electronic tag 17, illustrated by way of example with a frame around the authenticated person 13. The other people 13 illustrated do not have such an electronic tag 17.

The method according to the disclosure now carries out the following steps: Granting a first access authorization to the person 13 by means of the authentication device 15, as illustrated with the issued electronic tag 17 on the person 13 illustrated next to the authentication device 15. Specific data relating to the person 13 is then recorded after the authentication. This specific data is, for example, the precise position of the person 13 within the sensor detection region 14 and/or the movement speed and/or the movement direction and/or the contour of the person 13. However, the specific data can also be data of the person 13, for example the appearance, particular visual features or, for example, a movement pattern. Such recognition can also be supported by the imaging camera 21, with which further, in particular optical, specific data can be recorded.

If the person 13 with the illustrated electronic tag 17 moves away from the position next to the authentication device 15, the movement of the person 13 within the sensor detection region is monitored by means of the sensor unit 12 on the entrance side I. If the person 13 with the electronic tag 17 shows a desire to enter, in particular by the person 13 approaching the leaf elements 11 of the sliding door system, opening of the leaf elements 11 of the door system 100 is activated by the door drives 10 being actuated with the regulating unit 16. An additional identification of the person 13 then takes place with the sensor unit 12, and the door system 100 is opened only in connection with the positive identification of the person 13 by means of the sensor unit 12. This avoids, for example, a first person 13 authenticating themselves at the authentication device 15 and obtaining the electronic tag 17, while another person 13 can pass through the door system 100 in that the other person 13 walks into the sensor detection region 14 of the sensor unit 12 and expresses a desire to enter the door system 100 by the person approaching the leaf elements 11. Through the cooperation of the sensor unit 12 and the associated monitoring of the movement and continuous identification of the authenticated person 13, the door system 100 can distinguish authenticated people 13 from unauthenticated people 13. This principle is also possible with a plurality of authenticated people 13 at the same time.

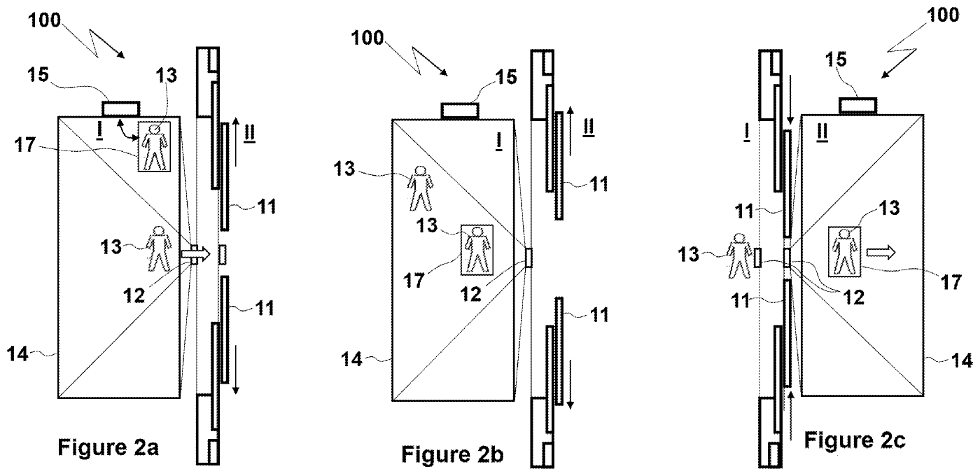

FIGS. 2a, 2b and 2c show an example of the sequence of the method for controlling the door system 100, with a person 13 first authenticating themselves at an authentication device 15 according to FIG. 2a, with a second person 13 standing directly in front of the leaf elements 11 of the door system 100 at the same time. If the person 13 authenticates themselves, illustrated with a frame reflecting the electronic tag 17, the door still remains closed according to FIG. 2a, even though the sensor unit 12 detects the person 13 without the electronic tag 17 within the sensor detection region 14 in front of the door leaves 11.

In FIG. 2b, the person 13 with the electronic tag moves directly in front of the leaf elements 11 such that they open, since the person 13 with the electronic tag 17 is authorized to enter the door system 100. The sensor unit 12 tracked the movement of the person 13 from the position according to FIG. 2a to the position according to FIG. 2b within the sensor detection region 14.

FIG. 2c shows the door system 100 again with the leaf elements 11 closed after the person 13 has passed through the door system 100. The other illustrated person 13 without the electronic tag 17 is not allowed to pass through the door system 100 such that despite the person 13 being detected by the sensor unit 12 on the entrance side I, the leaf elements 11 remain closed.

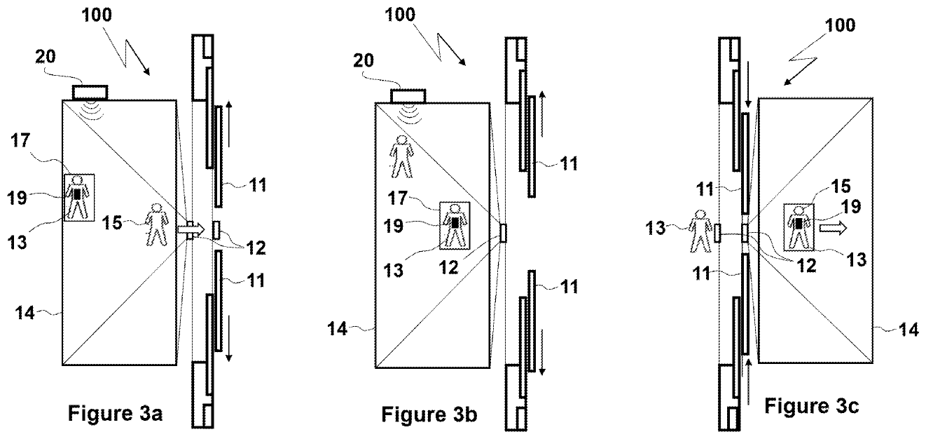

FIGS. 3a and 3b show another sequence of the method for controlling the door system 100, with a person 13 being shown with an electronic communication means 19, and the communication means 19 is detected by a detection device 20 on the entrance side I of the door system 100. If the communication means 19 is detected via the detection device 20, in particular contactlessly, the person 13 obtains the electronic tag 17 in order to be allowed to pass through the door system 100. The detection device 20 thereby forms another type of authentication device 15 which, however, is not designed as an access point, but rather the communication means 19, for example a mobile phone of a person, is detected contactlessly.

If the communication means 19 is detected, the sensor unit 12 can record the position of the person 13 within the sensor detection region 14 as a corresponding attribute such that a subsequent movement of the person 13, for example between the position of FIG. 3a and the position of FIG. 3b, is tracked. It can thus be seen that, according to FIG. 3b, an authenticated person, who can pass through the door system 100, is standing in front of the leaf elements 11, while, according to FIG. 3a, an unauthenticated person 13 is standing in front of the leaf elements 11, and they remain closed although the sensor unit 12 detects the person 13. In FIG. 3c, the authenticated person 13 with the electronic tag 17 has passed through the door system 100. The electronic tag 17 according to this embodiment can also be formed by the communication means 19 itself.

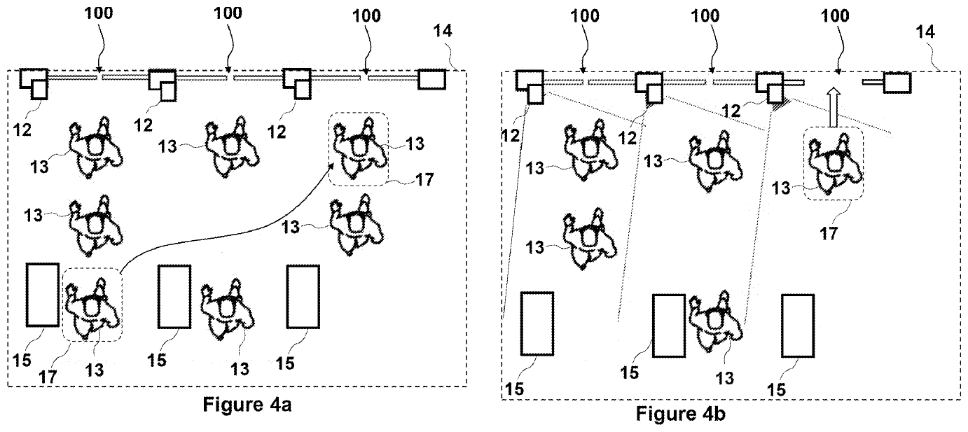

FIGS. 4a and 4b show a further embodiment of the disclosure with a plurality of door systems 100 which are entered by a plurality of people 13 at the same time. Each door system 100 has its own authentication device 15, and, in the transition from FIG. 4a, the person 13, who has authenticated themselves at the authentication device 15 and therefore has an electronic tag 17, changes the region in front of the left door system 100 and enters the region in front of the right door system 100. The door systems 100 each have sensor units 12 forming a common sensor detection region 14 which extends continuously in front of all the door systems 100 and is denoted generally by 14. The door system 100 is controlled in such a way that if the person 13 is authenticated once at one of the present authentication devices 15, they can pass through any of the door systems 100 by the door systems 100 being controlled centrally via a common regulating unit and the authenticated person 13 with the attached electronic tag 17 being continuously tracked as they move and change location within sensor detection region 14.

The design of the disclosure is not restricted to the preferred exemplary embodiment indicated above. In fact, a number of variants is conceivable which make use of the represented solution even in the case of fundamentally different designs. All features and/or advantages emerging from the claims, the description or the drawings, including constructive details or spatial arrangements, may be essential to the disclosure by themselves and in the most varied combinations.

1. A method for controlling at least one door system for separating an entrance side in front of the door system from an exit side behind the door system, wherein the door system has at least one door drive for moving at least one leaf element between an open position and a closed position, and wherein the door system is configured with a sensor unit for detecting at least one person within a sensor detection region, and furthermore an authentication device for authenticating people is provided at least on the entrance side in front of the door system; the method includes at least the following steps:
granting an access authorization to the person by the authentication device,
detecting the position of the authenticated person by the sensor unit in the sensor detection region,
continuous tracking of the person in the sensor detection region by the sensor unit, and
activating an opening of the leaf element of the door system by the door drive when the authenticated person approaches the at least one leaf element.

2. The method for controlling a door system according to claim 1,
whereby
a regulating unit is configured which continuously and dynamically on an ongoing basis regulates the position of the leaf element based on the sensor data of the sensor unit as a function of the movement and/or the contour of the person, at least indirectly via the door drives.

3. The method for controlling a door system according to claim 1,
wherein t a regulating unit, in particular as part of the door system, is configured, wherein the authenticated person is differentiated from the unauthenticated person with the regulating unit by the authenticated person being provided with an electronic tag after authentication, which is electronically attached to the person.

4. The method for controlling a door system according to claim 1,
wherein at least one image evaluation unit is configured in connection with the at least one sensor unit, wherein the continuous tracking of the movement of the person over their entire detection duration and/or the entire detection region being carried out at least in a supporting manner by the image evaluation unit and made available to the regulating unit.

5. The method for controlling a door system according to claim 1,
wherein the person carries with them an electronic communication means and wherein the door system and/or the sensor unit has a detection device as an authentication device, wherein if the person enters the sensor detection region, the electronic communication means is detected by the detection device in spatial connection with the person carrying it and wherein the electronic tag is attached to the person carrying it.

6. The method for controlling a door system according to claim 1,
whereby if the authenticated person intends to pass through the door system and approaches the at least one leaf element, the regulating unit opens the at least one leaf element at least indirectly via the door drive so far and/or for so long that only the authenticated person can pass through the door system.

7. The method for controlling a door system according to claim 1,
wherein a sensor unit is configured on the entrance side and on the exit side of the door system in each case and/or wherein the sensor detection regions of both sensor units overlap, adjoin one another or at least have a distance from one another that is smaller than the dimension of an in particular small person such that the at least one object is detected passing from a first sensor detection region to the one second sensor detection region and in particular without interruption.

8. The method for controlling a door system according to claim 1,
wherein the door system has two leaf elements, wherein the movements of the leaf elements are regulated continuously and dynamically on an ongoing basis independently of one another by the regulating unit, at least indirectly via the door drives.

9. The method for controlling a door system according to claim 1,
whereby with the at least one sensor unit and with the associated sensor detection region, protection of the closing edges of the at least one leaf element is carried out by an evaluation of sensor data of the sensor unit via the regulating unit.

10. The method for controlling a door system according to claim 1,
wherein the door system and/or the sensor unit has at least one imaging camera with which the face of the person, in particular in interaction with the regulating unit, is recognized, wherein the recognition of the person is also taken into account for determining an access authorization for the door system.

11. Method for controlling a plurality of door systems according to claim 1,
wherein a plurality of door systems are controlled by a common regulating unit or in that a plurality of door systems have respective regulating units between which data is exchanged, wherein when a person is authenticated by the at least one authentication device (15) and/or the detection device at a first door system, the person can also pass through another door system configured to be accessible in parallel.

12. The method for controlling a door system according to claim 1, wherein specific attributes of the person, in particular the size or other contour, are recognized by the image evaluation unit, in that the continuous tracking of the movement of the person can take place, based on the attributes.

13. The method for controlling a door system according to claim 1, whereby the data of the sensor unit is analyzed by artificial intelligence, in particular an artificial intelligence system, in particular as part of the regulating unit, wherein the artificial Intelligence system has and/or implements a machine learning system, a deep learning system, a neural network, contour recognition and/or pattern recognition, wherein the contour recognition and/or pattern recognition are used for re-authentication and/or for continuous tracking of the movement of the person.

14. A door system with a regulating unit for carrying out a method according to claim 1.

15. The door system according to claim 14,
wherein the regulating unit, in connection with at least one sensor unit, is designed to distinguish an authenticated person from an unauthenticated person by the regulating unit and/or the sensor unit tracking a person who has been authenticated once within the sensor detection region.

16. The door system according to claim 14,
wherein the door system and/or in particular the regulating unit has a sound output means, light output means and/or voice output means in order to give a signal or provide a message to the person.

17. The door system according to claim 14,
wherein the sensor unit has at least one, cameras and/or in that the sensor unit has at least one light source with which a light grid can be projected into the sensor detection region and/or wherein the sensor unit has an imaging camera for facial recognition of the person, in particular in connection with the regulating unit.
